(19) United States
(12) Patent Application Publication
(10) Pub. No.: US 2025/0130916 A1
(43) Pub. Date: Apr. 24, 2025

(54) System and method for monitoring the operation of a computer

(71) Applicant: THALES, Meudon (FR)

(72) Inventors: Jimmy LE RHUN, PALAISEAU CEDEX (FR); Sylvain GIRBAL, PALAISEAU CEDEX (FR)

(21) Appl. No.: 18/725,758

(22) PCT Filed: Dec. 30, 2022
(86) PCT No.: PCT/EP2022/088069

§ 371 Date: Nov. 28, 2024

(30) Foreign Application Priority Data
Dec. 30, 2021 (FR) FR2114671

(51) Int. Cl. G06F 11/34; G06F 9/48

(52) U.S. Cl. CPC G06F 11/3409; G06F 9/4881

(57) ABSTRACT

A system for monitoring the operation of a computer including hardware blocks including a plurality of cores, a set of task schedulers capable of scheduling the execution of a task by assigning it an identifier, and of storing the identifier, the monitoring system including a collection unit capable of counting the number of queries of each hardware block during the execution of a task, of reading the identifier of the executed task in a first memory storage unit, of forming an association between a query and the corresponding identifier, and of storing each association formed on a second memory storage unit, and a monitoring unit capable of determining the state of operation (operating status) of the computer by using the stored associations.

### CROSS-REFERENCE TO RELATED APPLICATIONS

This application claims benefit under 35 USC § 371 of PCT Application No. PCT/EP2022/088069 entitled SYSTEM AND METHOD FOR MONITORING THE OPERATION OF A COMPUTER, filed on Dec. 30, 2022 by inventors Jimmy Le Ruhn and Sylvain Girbal. PCT Application No. PCT/EP2022/088069 claims priority of French Patent Application No. 21 14671, filed on Dec. 30, 2021.

### FIELD OF THE INVENTION

The present invention relates to an operation monitoring system for monitoring the operation of a computer. The present invention also relates to an operation monitoring method for monitoring the operation of a computer.

### BACKGROUND OF THE INVENTION

The field of reliable critical on-board computers is faced with problems relating to the protection of systems that use such on-board computers (and possibly the users of the said systems) in the context of failure or breakdown of the computers (operational safety issues), as well as resistance to malicious attacks (cybersecurity).

In order to address the said issues, it is desirable for on-board (or embedded) computers to be compliant with constraints expressed in the form of properties to be ensured, including for example: with regard to security-confidentiality, integrity and availability; or indeed with regard to operational safety-reliability, real-time behaviour and traceability.

In large part, the certification of these critical computers therefore consists in providing for, demonstrating, and testing these properties, the foregoing being made possible by a suite of systems for performing surveillance (more often referred to as “monitoring systems”) that provide the means both for designing secure systems in advance, and for observing any deviations generated by cyber attacks.

Such monitoring systems include Intrusion Detection Systems (more commonly known by the corresponding abbreviation IDS), which already make use of operation monitoring data from software applications for detecting cyber attacks.

In particular, systems referred to as HIDS are also well known. In the aforementioned name, the ‘H’ referring to the corresponding established term “Host” is added to the previously mentioned abbreviation ‘IDS’. HIDS systems focus on a computer, at the level of its operating system. HIDS systems seek to detect abnormal behaviour by monitoring processes currently being run, allocations of memory, users who are logged in and so on. An alert is generated when one of the variables monitored by the HIDS system in question deviates from a predefined norm.

Furthermore, within the domain of operating safety and security and in the context of the use of multi-core hardware architectures, it is also common practice to use systems designed to provide for a sufficient level of segregation between software programs having shared hardware resources.

On the one hand, use is made of control systems which generally exploit a system of time windows and prevent the use of hardware resources by applications outside the windows assigned to that application, thus ensuring stringent partitioning and predictable time behaviour at the cost of a drop in performance.

On the other hand, use is made of regulation systems, which are more flexible but offer fewer stringent assurances; these systems monitor the use of hardware resources in real time, and only react in the event of a bottleneck in the path of these resources.

However, these systems do not serve to enable the detecting of attacks that exploit hardware vulnerabilities at the processor level, such as the Spectre attack, the Meltdown attack or the Rowhammer attack.

There is therefore a need for an operation monitoring system for monitoring the operation of a computer that provides for enhanced security for the computer.

### SUMMARY OF THE DESCRIPTION

To this end, the description discloses an operation monitoring system for monitoring the operation of a computer, the computer comprising hardware blocks, with the hardware blocks comprising a plurality of cores; the computer also comprising a set of task scheduling units, the task scheduler set being capable of scheduling the execution of a task by assigning it an identifier, and of storing the identifier on a first memory storage unit. The monitoring system comprises a collection unit capable of counting the number of queries of each hardware block during the execution of a task, the collection unit also being capable of reading the identifier of the executed task in the first memory storage unit, the collection unit also being capable of forming an association between a query and the corresponding identifier, and of storing each association formed on a second memory storage unit. The monitoring system also comprises a monitoring unit capable of determining the state of operation (operating status) of the computer by using the stored associations.

The monitoring system, by using a dedicated memory for the collection of monitoring data, makes it possible to provide for a higher level of security. This is because the dedicated memory can only be accessed from the hardware elements and not from the software. This makes it possible to prevent the data collected from being accessed by applications and thus to prevent them from being exploited for malicious purposes.

It should also be noted that each task herein is a software task and the collection unit is a hardware block (physical component). This implies that the collection unit has no a priori information about the tasks, which are in fact scheduled by the operating system.

According to some particular embodiments, the operation monitoring system presents one or more of the following characteristic features, taken into consideration in isolation or according to any technically possible combination:
a hardware block is a main memory shared by the cores, with the memory storage unit forming part of the main memory.
a hardware block is a debug support unit shared by the cores, with the memory storage unit forming part of the debug support unit.
the memory storage unit is a memory unit that is specific to a core.
each core comprises a tightly coupled memory unit, the memory unit specific to a core (core-specific memory) being the tightly coupled memory unit.
each core comprises a memory management unit, the memory unit specific to a core (core-specific memory) being located within the memory management unit.
each core comprises a performance measurement unit, the memory unit specific to a core (core-specific memory) being contained within the performance measurement unit.
each core comprises a performance measurement unit, the collection unit being formed by the entire set of performance measurement units.
the first memory storage unit is distinct from the second memory storage unit.

The description also discloses an operation monitoring method for monitoring the operation of a computer, the computer comprising hardware blocks, with the hardware blocks comprising a plurality of cores; the computer also comprising a set of task scheduling units, the task scheduler set being capable of scheduling the execution of a task by assigning it an identifier, and of storing the identifier on a first memory storage unit; the method being operationally implemented by an operation monitoring system comprising a collection unit and a monitoring unit; the method comprising: a counting step of counting the number of queries of each hardware block during the execution of the task, a reading step of reading the identifier of the executed task in the first memory storage unit, an association step of forming an association between a query and the corresponding identifier and storing each association formed on a second memory storage unit, and an operating status determination step of determining the state of operation of the computer by using the stored associations.

### BRIEF DESCRIPTION OF THE DRAWINGS

The characteristic features and advantages of the invention will become apparent upon reading the following description, provided solely by way of non-limiting example, and with reference made to the appended drawings, in which:

FIG. 1 is a schematic representation of an example of a computer;

FIG. 2 is a schematic representation of the processes that are implemented by the computer; and

FIG. 3 is a schematic representation of another example of a computer.

### DETAILED DESCRIPTION OF EMBODIMENTS

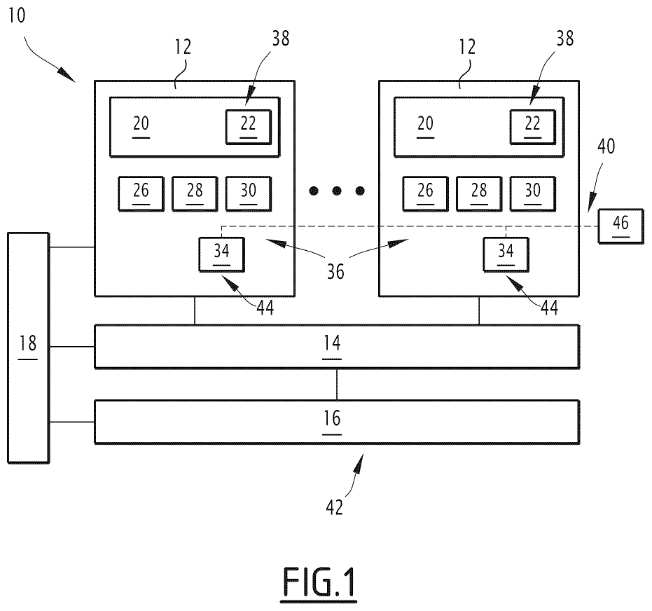

A computer 10 is represented schematically in FIG. 1.

The computer 10 is, for example, an on-board (embedded) computer, in particular a critical computer.

Such a computer 10 may be used in an airplane, in a payload or a satellite platform, or in implanted medical systems.

According to the example described, the computer 10 is a multi-core computer.

The computer 10 comprises a plurality of cores 12, an interconnect 14, a main memory 16 and a debug support unit 18.

A core 12 is a set of circuits capable of executing programmes in an autonomous manner.

Only two cores 12 are represented in FIG. 1 for simplicity, bearing in mind that the number of cores 12 is possibly far greater.

Each core 12 includes a computing unit 20 that comprises a scheduling unit 22, cache memories 26, a tightly coupled memory unit 28, a memory management unit 30, and a performance measurement unit 34.

The computing unit 20 is the unit that executes the various tasks.

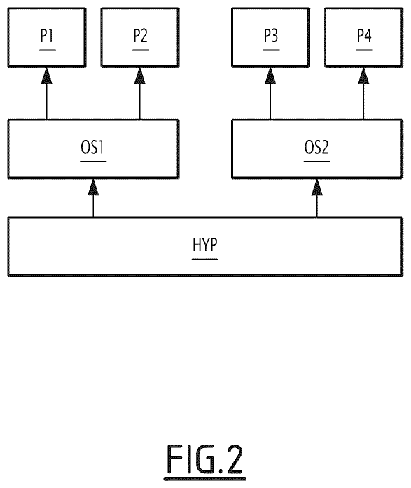

An example of the operation of the computing unit 20 from the software perspective is illustrated in FIG. 2.

In this figure, a HYP hypervisor implements two operating systems OS1 and OS2. They all include a scheduling unit 22.

Each of these operating systems OS1 and OS2 in turn implements two respective processes. The first operating system OS1 implements a first process P1 and a second process P2, while the second operating system OS2 implements a third process P3 and a fourth process P4.

Each process P1, P2, P3 or P4 corresponds to a set of a plurality of tasks.

The implementation of these tasks is managed by the scheduling unit 22.

The entire set of scheduling units 22 forms a task scheduler set 38 which is capable of scheduling the execution of a task by assigning it an identifier, and of storing the identifier on a memory storage unit. By definition, a cache memory is a memory unit that temporarily stores copies of data originating from a source, in order to reduce the time required for subsequently accessing or retrieving (reading) these data by computer hardware (generally a processor).

In the proposed example, the core comprises a plurality of cache memories 26 represented in the form of a single block in FIG. 1.

By way of example, it is standard practice to distinguish between a cache memory that stores code and a cache memory that stores data.

A tightly coupled memory 28 is a memory unit that is capable of explicitly storing instructions or data private to a core 12, with access times comparable to the cache memory 26 but without generating implicit transactions on the interconnect 14.

Such a memory unit is more often referred to as TCM, the corresponding abbreviation for the term “Tightly Coupled Memory”.

The memory management unit 30 is used to control instances of accessing the memory.

The memory management unit 30 is more commonly referred to by the corresponding abbreviation MMU.

The performance measurement unit 34 is capable of counting the number of queries of each element of the core 12 during the execution of a task by the computing unit 20.

Such a performance measurement unit 34 is often referred to by the abbreviation PMU corresponding to the commonly accepted terminology “Performance Monitoring Unit”.

According to the various embodiments, the core 12 just described has other elements and/or does not include all of the previously described blocks.

By way of example, the core 12 may comprise an Interrupt Controller (also known as an IC block referring to its corresponding abbreviation). As its name suggests, the interrupt controller manages interrupts.

The interconnect 14 is used to provide for the interconnection between the various elements of the cores 12 and shared elements such as the main memory 16.

According to the example described, the interconnect is a NoC interconnect because it is assumed that the cores 12 are part of the same chip.

The acronym NoC refers to the corresponding term “Network on Chip”.

The main memory 16 is capable of storing the data shared between the cores 12.

Given that its storage capacity is greater than that of the tightly coupled memories 28, the main memory 16 is able to store large amounts of data. It also enables data to be exchanged between cores 12.

The unit providing debugging support 18 is a unit that is capable of observing the proper execution of the software on the various elements of the computer 10 in order to fine tune this software.

As per commonly accepted terminology this unit is more often referred to as the “Debug Support Unit” 18.

The computer 10 thus comprises a set of hardware blocks 36, the task scheduler set 38, an operation monitoring system 40, and a memory storage unit 42.

A hardware block 36 is a physical component that is capable of executing tasks of varying degrees of complexity.

Some of the hardware blocks 36 have already been described above.

For example, the elements of the cores 12 or the main memory 16 are hardware blocks 36.

In addition, in FIG. 1, it is apparent that the memory storage unit 42 is contained within the main memory 16.

Other possible implementation embodiments may be envisaged such as allocating a small portion of the memory 16 for the storage of task identifiers, or storing the task identifiers in the performance measurement unit 34 or in the tightly coupled memory unit 28.

The monitoring system 40 is capable of monitoring the operation of the computer 10.

The monitoring system 40 is thus capable of implementing an operation monitoring method for monitoring the operation of the computer 10.

The monitoring system 40 comprises a collection unit 44 and a monitoring unit 46.

The collection unit 44 is capable of counting the number of queries of each hardware block 36 during the execution of a task.

It should be noted that the term “task” is used herein in a generic sense, and may refer to all or part of the following levels: a thread, a process, a partition, a virtual machine, a user co-routine, or an interrupt request.

The collection unit 44 is also capable of reading the identifier of the executed task in the storage unit 42.

The collection unit 44 is also capable of forming an association between a query and the corresponding task identifier.

The collection unit 44 is also capable of storing each association formed.

In the case of FIG. 1, the collection unit 44 is also formed by the performance measurement units 34.

This interaction is shown by a dotted line in FIG. 1.

The monitoring unit 46 is capable of determining the state of operation (operating status) using the stored associations.

The operation of the monitoring system 46 is described here below with reference to an exemplary implementation of an operation monitoring method for monitoring the operation of the computer 10, the monitoring method comprising a number of steps which are explained here below.

The scheduling unit 22 schedules the execution of a first task by assigning it an identifier.

The identifier is therefore a task identifier in the sense that it is specific to the task that it identifies.

In the remainder of this description, the identifier of the first task is referred to as the first identifier.

The scheduling unit 22 then stores the first identifier on the memory storage unit 42, in this case in the main memory 16.

The first task is then effectively implemented.

Such an implementation involves the sending of queries from the hardware blocks 36.

The performance measurement units 34 count each of these queries for each core 12.

For the sake of clarity, the queries for the first task are referred to as “first hardware queries” in the remainder of this description.

The collection unit 44 simultaneously reads the first identifier in the zone 42 and each of the first hardware queries in the performance measurement unit 34.

The collection unit 44 stores the association of the first identifier with the first hardware queries in the main memory 16, for example.

Each of the foregoing steps is reiterated for a second task.

Using the same formalism for naming the identifier and the queries, this reiteration of the steps may be described as follows.

The scheduling unit 22 subsequently schedules the execution of a second task by assigning it a second identifier which is stored in the memory storage unit 42.

Then, the performance measurement units 34 count the second hardware queries, and the collection unit 44 associates them with the second identifier. The collection unit 44 stores the said association in the main memory 16.

Thus these steps could be reiterated for each instance of implementation of the tasks.

A database is thus constituted which associates the hardware queries counted with a specific task.

By using this database, the monitoring unit 46 determines the state of operation of the computer 10.

For example, when the level of queries from a hardware block 36 is too high for a given task, this may be a sign of impairment or alteration in the operation of the computer 10.

Given that the monitoring system 40 has context related information linked to a higher query level of a hardware block 36, this provides the means to ensure additional monitoring insofar as it makes possible the detection of an attack that changes the number of instances of accessing a hardware block 36.

The monitoring system 40 is therefore capable of detecting attacks that exploit hardware vulnerabilities at the processor level and generate queries, such as the Specter attack, the Meltdown attack or the Rowhammer attack.

As a result, the monitoring system 40 effectively provides for enhanced security for the computer 10.

In addition, the monitoring system 40 is compatible with operational implementation in real-time.

It should be noted that the memory storage unit 42 may be different from the main memory 16 which thus poses the problem of being relatively far from the cores 12 and therefore of requiring relatively long instances of access.

In particular, the memory storage unit 42 may be located in the memory management unit 30.

Such an exemplary implementation has no impact on the transactions within the computer 10.

It is also possible to use the debug support unit 18, the performance measurement units 34, or the tightly coupled memories 28.

Finally, it should be noted that it is not necessary for the identifier to be stored on the same memory storage unit 42.

For example, it may be advantageous to store the identifiers in a local memory of a core 12 while the association would be stored in a shared memory unit.

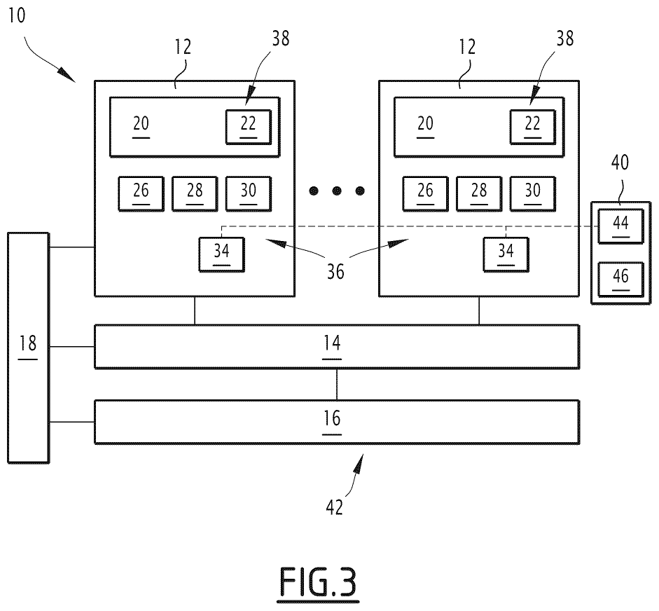

Another embodiment of the computer 10 is represented in FIG. 3.

The same remarks as for the computer 10 represented in FIG. 1 are also applicable to the one represented in FIG. 3. As well, attention is drawn here below only to the differences there-between.

In this case, the collection unit 44 is capable of collecting the data and information originating from the performance measurement units 34.

Unlike the embodiment in FIG. 1, the collection unit 44 in this instance is a centralised unit.

1. A system for monitoring the operation of a computer, the computer comprising:
hardware blocks, with the hardware blocks comprising a plurality of cores;
a set of task scheduling units, the task scheduler set scheduling execution of a task by assigning it an identifier, and storing the identifier on a first memory storage unit, the monitoring system comprising:
a collection unit counting the number of queries of each hardware block during execution of a task, reading the identifier of the executed task in the first memory storage unit, forming an association between a query and the corresponding identifier, and storing each association formed on a second memory storage unit; and
a monitoring unit determining the state of operation of the computer by using the stored associations.

2. A system according to claim 1, wherein each task is a software task and said collection unit is a physical component.

3. A system according to claim 1, wherein a hardware block is a main memory shared by the cores, with the memory storage unit forming part of the main memory.

4. A system according to claim 1, wherein a hardware block is a debug support unit shared by the cores, with the memory storage unit forming part of the debug support unit.

5. A system according to claim 1, wherein the memory storage unit is a memory unit that is specific to a core.

6. A system according to claim 5, wherein each core comprises a tightly coupled memory unit, the memory unit specific to a core being the tightly coupled memory unit.

7. A system according to claim 5, wherein each core comprises a memory management unit, the memory unit specific to a core being located in within the memory management unit.

8. A system according to claim 5, wherein each core comprises a performance measurement unit, the memory unit specific to a core being contained within the performance measurement unit.

9. A system according to claim 5, wherein each core comprises a performance measurement unit, said collection unit being formed by the entire set of performance measurement units.

10. An operation monitoring system according to claim 1, wherein the first memory storage unit is distinct from the second memory storage unit.

11. A method for monitoring the operation of a computer, the computer comprising:
hardware blocks, with the hardware blocks comprising a plurality of cores;
a set of task scheduling units, the task scheduler set scheduling execution of a task by assigning it an identifier, and storing the identifier on a first memory storage unit;
the method being operationally implemented by an operation monitoring system comprising a collection unit and a monitoring unit, the method comprising:
counting the number of queries of each hardware block during the execution of a task;
reading the identifier of the executed task in the first memory storage unit;
forming an association between a query and the corresponding identifier and storing each association formed on a second memory storage unit; and
determining the state of operation of the computer by using the stored associations.
